(19) United States
(12) Patent Application Publication
(10) Pub. No.: US 2018/0195672 A1
(43) Pub. Date: Jul. 12, 2018

(54) LED Light Bulb

(71) Applicant: FOSHAN ELECTRICAL AND LIGHTING CO., LTD, Foshan (CN)

(72) Inventors: Bin Wei, Foshan (CN); Yiguang Zhu, Foshan (CN); Junjie Zhao, Foshan (CN); Hengyao Cao, Foshan (CN)

(21) Appl. No.: 15/638,417

(22) Filed: Jun. 30, 2017

(30) Foreign Application Priority Data
Jan. 10, 2017 (CN) 201710014652.4

(51) Int. Cl. F21K 9/237; F21K 9/232

(52) U.S. Cl. CPC F21K 9/237; F21Y 2115/10; F21K 9/232

(57) ABSTRACT

This invention relates to technical field of LED lighting, disclosing a LED light bulb including a bulb housing, at least two LED light sources provided onto the inner wall of the bulb housing, a lamp holder connected to the bulb housing and a shielding member provided onto the outer wall of the bulb housing. The shielding member matches with the LED light source in shape and position. The LED light sources located at the inner wall of the bulb housing are equidistant. The LED light source includes a substrate and a LED component provided on the substrate. The substrate matches with the bulb housing in shape. In the provided LED light bulb, the shielding member is disposed onto the outer wall of the bulb, having positions match with the LED light source with equal intervals. The LED light bulb may achieve the full-circumference lighting and more even light emission.

### CROSS-REFERENCE TO RELATED APPLICATIONS

The present application claims the benefit of Chinese Patent Application No. 201710014652.4 filed on Jan. 10, 2017, the contents of which are hereby incorporated by reference.

### TECHNICAL FIELD

The present invention relates to technical field of LED lighting, more particularly, to a new LED light bulb.

### BACKGROUND

As a new generation of green light, LED has advantages of energy saving, long life and etc. With the development of society, it is inexorable trend to replace the traditional lighting with the LED lighting. The appearance of traditional LED light bulbs is widely accepted. Therefore, most of the available LED bulbs are made with similar appearance to the traditional LED light bulbs, including an LED light source, a bulb housing and a bulb holder. The LED light source is attached to the interior of the bulb housing by a stem or a radiator, and then being packaged. On one hand, the manufacture of such LED lighting bulbs is complicated, with low the production efficiency. On the other hand, the LED light source generates higher heat when in use and the generated heat cannot be dissipated in time as the LED light source is arranged within the bulb housing. In such case, the persistently high temperature will damage the serving life of the LED light bulb heavily. Accordingly, there is a need to provide a new LED light bulb for solving the above identified problems.

The present invention provides a new LED light bulb, wherein the LED light source is directly arranged on the inner wall of the bulb housing, leading to faster heat dissipation, simpler manufacturing, and longer service life of the LED light bulb.

### SUMMARY OF THE INVENTION

The object of the invention is to provide a new LED bulb, in which the LED light source is directly arranged on the inner wall of the bulb housing. By doing so, the heat radiation become faster, the production process become simpler, and the service life gets longer.

In order to solve the above technical problems, the present invention provides a new LED light bulb, comprising a bulb housing, at least two LED light sources provided onto the inner wall of the bulb housing, a lamp holder connected to the bulb housing and a shielding member provided onto the outer wall of the bulb housing. The shape and position of the shielding member matches with the shape and position of the LED light source.

The LED light sources located at the inner wall of the bulb housing are equidistant from each other. The LED light source comprises a substrate and a LED component provided on the substrate. The shape of the substrate matches with the shape of the bulb housing.

Preferably, the shielding member is a coating or covering member provided on the outer wall of the bulb housing.

Preferably, the inner wall of the bulb housing comprises an LED light source installation region and a transparent region. Furthermore, a coarse construction is provided on the inner wall or outer wall of the bulb housing, at least on the LED light source installation region.

Preferably, the quantity of the LED light source is three, and the intervals between the LED light sources on the inner wall of the bulb housing is equidistant.

Preferably, the substrate is a flexible substrate or a non-flexible substrate.

Preferably, a power supply is provided within the lamp holder; or the LED light source further comprises a power supply. Preferably, the shielding member is a coating, the quantity of the coating is equal to the quantity of the LED light source.

Preferably, the shielding member is a radiation coating.

Preferably, the shielding member is a nanometer paint.

Preferably, the shielding member is the covering member. The covering member is formed as a whole unit, which comprises a base and a branch. The quantity of the branch is equal to the quantity of the LED light source.

Preferably, the covering member is a metallic covering member or a non-metallic covering member.

Compared to the prior art, the beneficial effects of the present invention are as below:

1. In the LED light bulb provided by the present invention, on one hand, the shielding member is arranged onto the outer wall of the bulb housing and the position of the shielding member matches with the position of the LED light source, so that the light source within the bulb housing can be shielded, preventing the light source from being viewed from outside of the LED light bulb and therefore improving the aesthetic feeling of the LED light bulb; on the other hand, there are at least two LED light sources and intervals therebetween are equal to each other. Such LED light bulb can achieve the full-circumference lighting and more even light emission.

2. In the LED light bulb provided by the present invention, a coarse construction is provided on the entire inner wall of the bulb housing. Such arrangement, on one hand, facilitates the diffused reflection of the light emitted from the LED light source on the surface of the bulb housing, preventing dazzle light, and eliminates hidden danger of coating mildew and powder fall; on the other hand, the surface area of the LED light installation region is increased, facilitating the installation of the LED light source and enhancing the binding force between the LED light source and the bulb housing.

3. In the LED light bulb provided by the present invention, the shielding member is made of the material with high thermal conductivity. The heat generated by the LED light source bulb is transmitted to the shielding member and dissipates rapidly, preventing the heat from gathering inside the LED light bulb, which will affect the serving life of the LED light bulb.

### BRIEF DESCRIPTION OF THE DRAWINGS

FIG. 1 is an exploded view of the LED light bulb according to Embodiment One of the present invention.

FIG. 2 is a three-dimensional diagram of the LED light bulb according to Embodiment One of the present invention.

FIG. 3 is an exploded view of the LED light bulb according to Embodiment Two of the present invention.

FIG. 4 is a three-dimensional diagram of the LED light bulb according to Embodiment Two of the present invention.

FIG. 5 is a light distribution curve diagram of the LED light bulb according to the present invention.

### DETAILED DESCRIPTION OF THE EMBODIMENT

In order to enable the one with ordinary skill in the art to better understand the technical solution of the present invention, more detail description in conjunction with the accompanying drawings and preferred embodiments are provided herein.

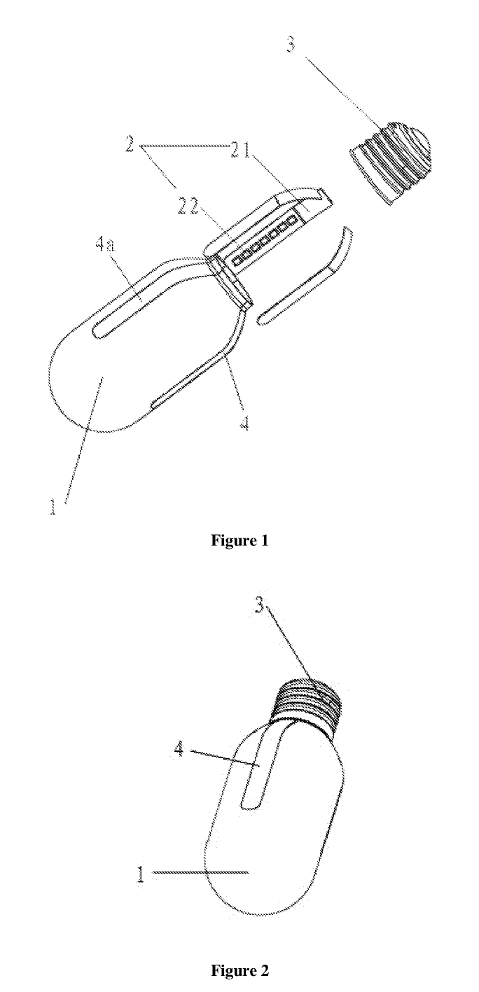

As shown in FIGS. 1-4, a new LED light bulb is provided. The LED light bulb comprises a bulb housing 1, at least two LED light sources 2 provided onto the inner wall of the bulb housing 1, a lamp holder 3 connected to the bulb housing 1 and a shielding member 4 provided onto the outer wall of the bulb housing 1. The shape and position of the shielding member 4 matches with the shape and position of the LED light source 2. The intervals of the LED light sources 2 are equidistant from each other. The LED light source 2 comprises a substrate 21 and a LED component 22 provided on the substrate. The shape of the substrate 21 matches with the shape of the bulb housing 1. The shielding member 4 is a coating or covering member provided onto the outer wall of the bulb housing 1.

The inner wall of the bulb housing 1 comprises an LED light source transparent region and an installation region. A coarse construction is provided on the inner wall of the bulb housing, at least on the LED light source installation region.

The bulb housing 1 is made of glass or plastic depending on the actual production needs. In the embodiment, the bulb housing 1 is made of glass. The inner wall of the bulb housing includes an LED light source installation region and a transparent region. The LED light source installation region is configured for mounting the LED light source, and the transparent region is configured for transmitting the light from the LED light source to outside of the bulb housing. A coarse construction is provided on the inner wall of the bulb housing, at least on the LED light source installation region. More preferably, the coarse construction is provided on the entire inner wall of the LED bulb housing, facilitating the diffused reflection of the light emitted from the LED light source on the surface of the bulb housing, preventing the light from being dazzle and eliminating hidden danger of coating mildew and powder fall.

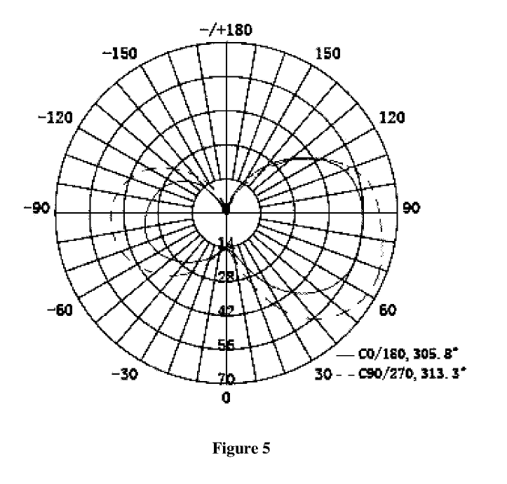

There is at least two of the LED light source provided to achieve the full-circumference lighting, as shown in FIG. 5. FIG. 5 is the light distribution curve diagram of the LED light bulb according to the present invention. It can be seen from the figure that the light emitting angle of the LED light bulb is larger than 300°. Such light emitting angle is large enough to achieve the full-circumference lighting.

The equidistant intervals of the LED light sources 2 allow for a more even light emission. The LED light source includes the substrate 21 and the LED component 22 provided on the substrate, wherein the substrate 21 may be a flexible or non-flexible. More specifically, there are two implementations as follows.

The substrate 21 is flexible. The LED component 22 is provided on the flexible substrate. Since the substrate is flexible, it may be bent to accommodate the shape of the bulb housing, so as to be matching with the shape of the bulb housing 1. In this case, the shape of the substrate 21 matches with the shape of the bulb housing 1 when the LED light sources 2 are mounted onto the inner wall of the bulb housing 1.

The substrate 21 is the non-flexible. The LED component 22 is provided on the non-flexible substrate, wherein the shape of the non-flexible substrate matches with the shape of the bulb housing 1.

The LED light sources 2 are provided on the LED light source installation region of the inner wall of the bulb housing 1. In the embodiment, the LED light source is provided on the LED light source installation region through adhesive. The LED light source installation region further comprises a coarse construction, whereby the contact area of the adhesive is increased, and the bonding force between the LED light source and bulb housing is enhanced. In such circumstances, the LED light source is prevented from falling off during transportation or under long-term use.

More preferably, the coarse constructions are also provided on one surface of the substrate 21 contacting with the bulb housing. Such design further increased the contact area of the adhesive and therefore the binding force between the LED light source 2 and the bulb housing 1 is enhanced.

The lamp holder 3 is configured to allow a mechanical and electrical connection between the LED light bulb and external power supply. Furthermore, because the lamp holder 3 has a driving power for converting the alternating current (AC) into direct current (DC), the LED bulb may work as normal even if there is no driver chip provided to the LED bulb. In another embodiment, the LED light source 2 may include a driving power. In this case, the lamp holder 3 may have the driving power inside.

The shielding member 4 is a coating or covering member arranged on the outer wall of the bulb housing. The shape, size and position of the shielding member 4 match with the shape, size and position of the LED light source 2. In the present invention, due to the arrangement that the LED light source 2 is directly arranged on the inner wall of the bulb housing 1, the shielding member 4 is provided on the outer wall of the bulb housing 1 and the position of which matches with the position of the LED light source, the light source inside the bulb housing may be shield and the LED light source 2 cannot be directly observed from the outside of the LED light bulb. In this case, the LED light bulb may have more aesthetic feeling.

More preferably, the shielding member 4 is made of the material with high thermal conductivity. The heat generated by the LED light source 2 is transmitted to the shielding member 4 through the bulb housing 1 and dissipates rapidly, preventing the heat from gathering inside the LED light bulb and improving the serving life of the LED light bulb.

Hereinafter some specific implementations of the LED light bulb according to the present invention is provided.

### Embodiment One

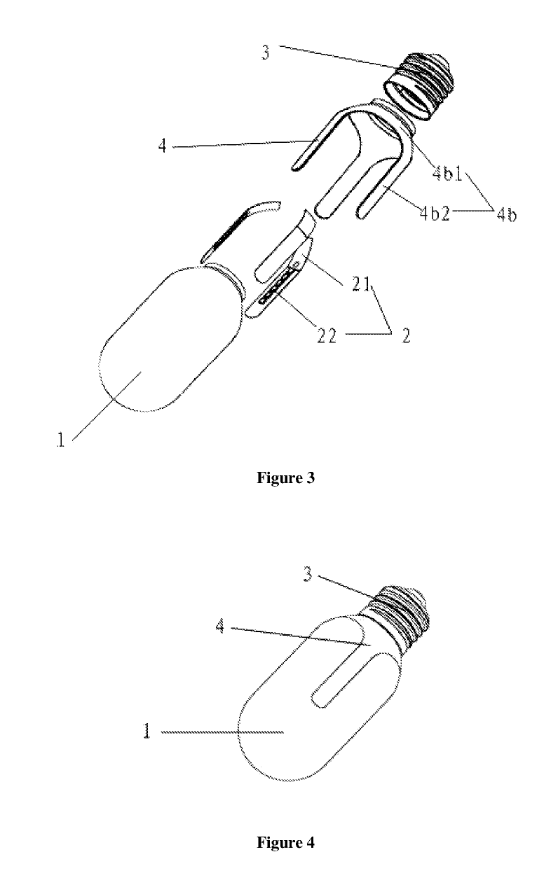

As shown in FIGS. 1-2, in the LED light bulb provided in the embodiment, the shielding member 4 is a coating. More specifically:

A new LED light bulb is provided, comprising a bulb housing 1, at least two LED light sources 2 provided onto the inner wall of the bulb housing 1, a lamp holder 3 connected to the bulb housing 1 and a shielding member 4 provided onto the outer wall of the bulb housing 1. The shape and position of the shielding member 4 matches with the shape and position of the LED light source 2. The LED light sources 2 includes a substrate 21 and a LED component 22 provided on the substrate. The shape of the substrate 21 matches with the shape of the bulb housing 1. The shielding member 4 is a coating provided on the outer wall of the bulb housing.

The inner wall of the bulb housing 1 includes an LED light source installation region and a transparent region. The coarse construction provided on the entire inner wall of the bulb housing, on one hand, facilitates the diffused reflection of the light emitted from the LED light source on the surface of the bulb housing, preventing the light from being dazzle; on the other hand, increases the surface area of the LED light installation region, facilitating the installation of the LED light source and enhancing the binding force between the LED light source and the bulb housing.

The LED light source 2 is composed of three bar light sources. The intervals therebetween on the bulb housing are equal to each other. The LED light source 2 includes a flexible substrate and an LED component provided on the flexible substrate. The flexible substrate is provided inside the bulb housing through adhesive. In this case, since the substrate is flexible, it can be bent to accommodate the shape of the bulb housing, facilitating the matching with the shape of the bubble housing.

The shielding member 4 is the coating 4a, provided onto the outer wall of the bulb housing 1, with the shape, size and position thereof matching with the shape, size and position of the LED light source.

There are three shielding members 4. The three shielding members 4 are equidistant on the bulb housing 1. In the embodiment, the shielding member 4 is the coating 4a. Specifically, the shielding member is a radiation coating. More preferably, the shielding member is a nanometer paint. The shielding member, on one hand, may shield the LED light source inside the bulb housing; on the other hand, the shielding member may facilitate the dissipation of the heat generated by the LED light source through the bulb housing.

### Embodiment Two

As shown in FIGS. 3-4, the LED light bulb provided in this embodiment differs from Embodiment One in that the shielding member is a covering member. More specifically:

A new LED light bulb is provided, comprising a bulb housing 1, at least two LED light sources 2 provided onto the inner wall of the bulb housing 1, a lamp holder 3 connected to the bulb housing 1 and a shielding member 4 provided onto the outer wall of the bulb housing 1. The shape and position of the shielding member 4 matches with the shape and position of the LED light source 2. The LED light sources 2 includes a substrate 21 and a LED component 22 provided on the substrate. The shape of the substrate 21 matches with the shape of the bulb housing 1. The shielding member 4 is a covering member 4b provided onto the outer wall of the bulb housing.

The inner wall of the bulb housing 1 includes an LED light source installation region and a transparent region. The coarse construction provided on the entire inner wall of the bulb housing 1, on one hand, facilitates the diffused reflection of the light emitted from the LED light source on the surface of the bulb housing and preventing the light from being dazzle light; on the other hand, increases the surface area of the LED light installation region, thereby facilitating the installation of the LED light source and enhancing the binding force between the LED light source and the bulb housing.

The LED light source 2 is composed of three bar light sources. The intervals of three the LED light sources on the bulb housing are equal to each other. The LED light source includes a non-flexible substrate and an LED component provided on the non-flexible substrate. The shape of the non-flexible substrate matches with the shape of the bulb housing and is provided inside the bulb housing through adhesive. Furthermore, the coarse construction is provided on one surface of the non-flexible substrate contacting the bulb housing so as to increase the surface area of the LED light source. Such arrangement further enhances the bonding force between the bulb housing and the LED light source.

The shielding member 4 is shown as the covering member 4b, provided onto the outer wall of the bulb housing, with the shape, size and position thereof matching with the shape, size and position of the LED light source 2.

The covering member 4b is formed as a whole unit, comprising a base 4b1 and a branch 4b2. There are three branches 4b2 and the intervals thereof on the bulb housing are equal to each other. In this embodiment, the shielding member 4 is shown as the covering member 4b. Specifically, the shielding member 4 is a metallic covering member or plastic covering member, such as PC covering member, PPT covering member or nylon covering member. On one hand, the covering member may shield the LED light source 2 inside the bulb housing; on the other hand, the covering member facilitates the dissipation of heat generated by the LED light source 2 through the bulb housing 1.

It is to be noted that that the aforementioned PC refers to polycarbonate, and PPT refers to materials based on macromolecular compound.

Compared to the prior art, the beneficial effects of the present invention are as follows:

1. In the LED light bulb provided by the present invention, on one hand, the shielding member is arranged onto the outer wall of the bulb housing and the position of the shielding member matches with the position of the LED light source, so that the light source within the bulb housing can be shielded, preventing the light source from being viewed from outside of the LED light bulb and therefore improving the aesthetic feeling of the LED light bulb; on the other hand, there are at least two LED light sources and intervals therebetween are equal to each other. Such LED light bulb can achieve the full-circumference lighting and more even light emission.

2. In the LED light bulb provided by the present invention, a coarse construction is provided on the entire inner wall of the bulb housing. Such arrangement, on one hand, facilitates the diffused reflection of the light emitted from the LED light source on the surface of the bulb housing, preventing dazzle light, and eliminates hidden danger of coating mildew and powder fall; on the other hand, the surface area of the LED light installation region is increased, facilitating the installation of the LED light source and enhancing the binding force between the LED light source and the bulb housing.

3. In the LED light bulb provided by the present invention, the shielding member is made of the material with high thermal conductivity. The heat generated by the LED light source bulb is transmitted to the shielding member and dissipates rapidly, preventing the heat from gathering inside the LED light bulb, which will affect the serving life of the LED light bulb.

Aforementioned embodiments are merely preferred embodiments of the present invention. It is to be noted that other modifications and changes may be made by the ordinary skilled person in the art without departing from the principles of the present invention. Such modifications and changes shall be deemed as falling within the scope of the present invention.

What is claimed is:

1. A LED light bulb, comprising a bulb housing, at least two LED light sources provided onto an inner wall of the bulb housing, a lamp holder connected to the bulb housing and a shielding member provided onto an outer wall of the bulb housing; wherein the shielding member matches with the LED light source in shape and position; and
wherein intervals between the LED light sources on the inner wall of the bulb housing are equal to each other; wherein the LED light source comprises a substrate and an LED component provided on the substrate; wherein the substrate matches with the bulb housing in shape.

2. The LED light bulb of claim 1, characterized in that, the shielding member is a coating or a covering member provided on the outer wall of the bulb housing.

3. The LED light bulb of claim 1, characterized in that the inner wall of the bulb housing comprises an LED light source installation region and a transparent region; wherein a coarse construction is provided on the inner wall or outer wall of the bulb housing, at least on the LED light source installation region.

4. The LED light bulb of claim 1, characterized in that three LED light source are used, wherein intervals of the LED light sources on the inner wall of the bulb housing are equal to each other.

5. The LED light bulb of claim 1, characterized in that the substrate is flexible or non-flexible.

6. The LED light bulb of claim 1, characterized in that a power supply is provided within the lamp holder; or the LED light source further comprises a power supply.

7. The LED light bulb of claim 2, characterized in that the shielding member is the coating, wherein the coating is identical to the LED light source in quantity.

8. The LED light bulb of claim 7, characterized in that the shielding member is a radiation coating.

9. The LED light bulb of claim 7, characterized in that the shielding member is a nanometer paint.

10. The LED light bulb of claim 2, characterized in that the shielding member is the covering member, wherein the covering member is formed as a whole unit which comprises a base and a branch; wherein the branch is identical to the LED light source in quantity.

11. The LED light bulb of claim 10, characterized in that the covering member is metallic or non-metallic.
